(19) United States
(12) Patent Application Publication
(10) Pub. No.: US 2009/0240925 A1
(43) Pub. Date: Sep. 24, 2009

(54) DEVICE, METHOD, AND COMPUTER PROGRAM PRODUCT THAT PROCESS MESSAGE

(75) Inventors: Takeshi Ishihara, Kanagawa (JP); Yasuhiro Fukuju, Kanagawa (JP); Keisuke Mera, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/372,008

(22) Filed: Feb. 17, 2009

(30) Foreign Application Priority Data
Mar. 24, 2008 (JP) 2008-075206

(51) Int. Cl. G06F 9/302

(52) U.S. Cl. 712/221; 712/E09.017

(57) ABSTRACT

A first arithmetic unit performs a network process for transmission and reception of a message. A second arithmetic unit performs a network process and a specific process that is predetermined to be performed on the message in relation with the network process. An alternate process management table stores therein process information in which associated identification information with an instruction sequence, the identification information being information for identifying a type of the message, the instruction sequence being a sequence for sequentially performing a network process and a specific process. The first arithmetic unit includes an identification information detector that detects the identification information from the message, and a controller that retrieves, from the alternate process management table, an instruction sequence corresponding to the identification information detected, so as to control the second arithmetic unit to perform the instruction sequence retrieved.

### CROSS-REFERENCE TO RELATED APPLICATIONS

This application is based upon and claims the benefit of priority from the prior Japanese Patent Application No. 2008-75206, filed on Mar. 24, 2008; the entire contents of which are incorporated herein by reference.

### BACKGROUND OF THE INVENTION

1. Field of the Invention

The present invention relates to a device, a method, and a computer program that process, using a plurality of arithmetic units, a message transmitted and received via a network.

2. Description of the Related Art

Moving image processing and encryption processing require a lot of computational resources. To configure a device that performs such processing, dedicated hardware for performing moving image processing and encryption processing, as well as a main processor, is generally installed and used as an alternate serving the processing. Another method uses a processor including a plurality of versatile arithmetic units, such as a multi-core processor, and assigns moving image processing and encryption processing to specific arithmetic units preferentially and exclusively, thereby enabling those units to serve as alternates for performing the processing.

In recent years, there has been an increasing demand for exchanging large volumes of data at high speed with a remote device via a network. As in the moving image processing and the encryption processing, network processing also requires a lot of computational resources for transmitting large volumes of data at high speed. For this reason, methods may be used that install dedicated hardware for performing such network processing, or that assign such network processing to specific arithmetic units in a processor preferentially and exclusively.

There has also been an increasing demand for transmitting a coded moving image at high speed. To realize such network nodes, such methods have widely been employed that use a plurality of pieces of hardware dedicated to different processes and enable them to serve as alternates for performing a series of processes sequentially, or that use a single high-performance hardware dedicated to a plurality of processes and enable it to serve as an alternate for performing a series of processes.

For example, JP-A 2006-109016 (KOKAI) discloses a technology that realizes the network interface, network processing, and moving image processing with a single dedicated hardware device, thereby reducing the load on a main processor.

The methods that sequentially use a plurality of pieces of dedicated hardware as alternates for performing a series of processes, such as moving image processing and network processing, require a main processor to control each piece of hardware. This poses a problem of increasing the overhead due to the complex processes and data movement. An effective method for solving the problem is to enable the alternates to perform a series of processes at one time. On the contrary, the methods using a single high-performance dedicated hardware and enabling it to serve as an alternate for performing a series of processes at one time allows the alternate to perform only limited processes, thus failing to achieve flexibility.

### SUMMARY OF THE INVENTION

According to one aspect of the invention, a message processor includes a first arithmetic unit capable of executing an instruction sequence defining processing content, a second arithmetic unit capable of executing an instruction sequence being same as or different from the instruction sequence executed by the first arithmetic unit, and a memory unit that stores therein process information in which associated identification information with an instruction sequence, the identification information being information for identifying a type of a message, the instruction sequence being a sequence for sequentially performing a network process for transmission or reception of the message, and a specific process to be performed on the message in relation with the network process. The first arithmetic unit includes an identification information detector that detects the identification information from the message, and a controller that retrieves from the memory unit an instruction sequence corresponding to the identification information detected, so as to control the second arithmetic unit to perform the instruction sequence retrieved.

According to another aspect of the invention, a method is performed in a message processor for processing message, wherein the message processor includes a first arithmetic unit capable of executing an instruction sequence defining processing content, and a second arithmetic unit capable of executing an instruction sequence being same as or different from the instruction sequence executed by the first arithmetic unit. The method includes detecting identification information from a message, and retrieving from a memory unit an instruction sequence corresponding to the identification information detected in the detecting, so as to control the second arithmetic unit to perform the instruction sequence retrieved, the memory unit storing therein process information in which associated identification information with an instruction sequence, the identification information being information for identifying a type of a message, and the instruction sequence being a sequence for sequentially performing a network process for transmission or reception of the message, and a specific process to be performed on the message in relation with the network process.

According to still another aspect of the present invention, a computer program product has a computer readable medium including programmed instructions executable by a computer for processing a message. The computer includes a first arithmetic unit capable of executing an instruction sequence defining processing content, a second arithmetic unit capable of executing an instruction sequence being same as or different from the instruction sequence executed by the first arithmetic unit, and a memory unit that stores therein process information in which associated identification information with an instruction sequence, the identification information being information for identifying a type of a message, and the instruction sequence being a sequence for sequentially performing a network process for transmission or reception of the message, and a specific process to be performed on the message in relation with the network process. The instructions, when executed by the computer, cause the computer to perform detecting the identification information from the message, and retrieving from the memory unit an instruction sequence corresponding to the identification information detected, so as to control the second arithmetic unit to perform the instruction sequence retrieved.

### BRIEF DESCRIPTION OF THE DRAWINGS

FIG. 1 is a schematic block diagram of a message processor according to a first embodiment of the present invention;

FIG. 2 is a diagram of an exemplary structure of data registered in an alternate process management table;

FIG. 3 is a flowchart of an overall flow of a packet reception process according to the first embodiment;

FIG. 4 is a flowchart of an overall flow of an instruction sequence generation process for packet reception according to the first embodiment;

FIG. 5 is a hardware configuration diagram of a message processor;

FIG. 6 is a hardware configuration diagram of a message processor;

FIG. 7 is a hardware configuration diagram of a message processor;

FIG. 8 is a schematic of processes performed using a first arithmetic unit and a second arithmetic unit;

FIG. 9 is a schematic of processes performed using a first arithmetic unit and two second arithmetic units;

FIG. 10 is a schematic of processes performed using a first arithmetic unit, and a second arithmetic unit provided in a network I/F unit;

FIG. 11 is a schematic of message processing performed by the message processor shown in FIG. 1;

FIG. 12 is a diagram of an exemplary entry registered in an alternate process management table;

FIG. 13 is a diagram of an exemplary entry registered in an alternate process management table;

FIG. 14 is a sequence diagram of a brief overview of message processing;

FIG. 15 is a flowchart of an overall flow of an instruction sequence generation process for packet transmission according to the first embodiment;

FIG. 16 is a flowchart of an overall flow of a packet transmission process according to the first embodiment;

FIG. 17 is a diagram of an exemplary data structure of an executable code address table;

FIG. 18 is a diagram of an exemplary structure of data registered in an alternate process management table;

FIG. 19 is a block diagram of a message processor according to a second embodiment of the present invention;

FIG. 20 is a flowchart of an overall flow of an instruction sequence generation process according to the second embodiment;

FIG. 21 is a flowchart of an overall flow of a packet reception process according to the second embodiment; and

FIG. 22 is a flowchart of an overall flow of a packet transmission process according to the second embodiment.

### DETAILED DESCRIPTION OF THE INVENTION

Exemplary embodiments of a device, a method, and a computer program according to the present invention will be described in detail with reference to the accompanying drawings.

A message processor according to a first embodiment of the present invention includes a plurality of versatile arithmetic units. In the message processor, a main arithmetic unit (a first arithmetic unit) performs a network process. The message processor detects a specific process, such as encryption, that is performed by another arithmetic unit (a second arithmetic unit) serving as an alternate in relation with the network process performed by the main arithmetic unit. The message processor generates an instruction sequence for sequentially performing the network process and the specific process, and stores it in a memory unit. Thereafter, the second arithmetic unit uses the stored instruction sequence to sequentially perform the network process and the specific process on a relevant message (packet).

In the first embodiment, assume that (1) when a network interface (I/F) unit receives a packet, a hardware interrupt is notified to the first arithmetic unit, and that (2) the main arithmetic unit receiving the notification of the hardware interrupt includes a mechanism for implementing an interrupt handler (an interrupt processor described later) that processes the received packet.

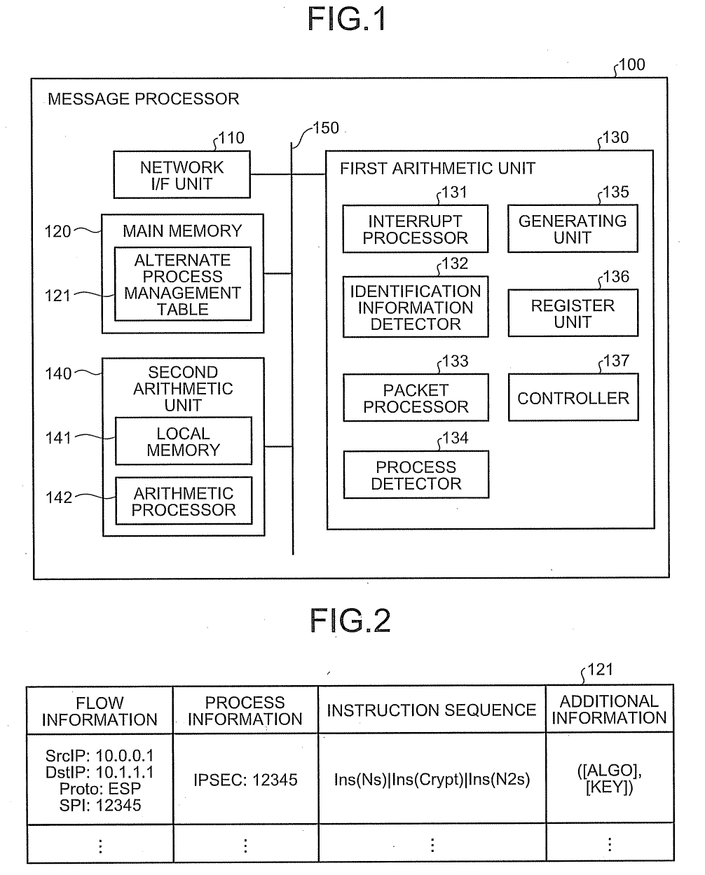

As shown in FIG. 1, a message processor 100 includes a network I/F unit 110, a main memory 120, a first arithmetic unit 130, a second arithmetic unit 140, and a bus 150 connecting the constituting elements.

The network I/F unit 110 is a device that enables the message processor 100 to transmit and receive a packet to and from an external device.

The main memory 120 is a memory device such as a random access memory (RAM) that stores therein various programs and various kinds of data to be handled in message processing. The main memory 120 is not limited to a RAM, but is constituted by any memory medium generally available, such as a memory card, an optical disk, or a hard disk drive (HDD). The main memory 120 stores therein an alternate process management table 121 for managing a correspondence relationship between flow information of a packet and an instruction sequence executed by the second arithmetic unit 140 as an alternate process.

As shown in FIG. 2, the alternate process management table 121 stores therein process information (hereinafter, “alternate process information”) that is data including flow information, process information, an instruction sequence, and additional information, the process information is the data that associates flow information, process information, instruction sequence, and additional information. In the alternate process management table 121, one row constitutes one entry (alternate process information).

The flow information is identification information for identifying a packet type. The flow information is a collection of pieces of specific information constituting a packet. For example, at least one of the following can be used as flow information: protocol information for identifying protocols, such as a media access control (MAC) address, an internet protocol (IP) address, a transmission control protocol (TCP) port number or a user datagram protocol (UDP) port number, and a security architecture for Internet protocol (IPsec), all contained in a packet; and an identifier for identifying a parameter used in a protocol, such as a security parameter index (SPI) for IPsec. Each piece of the information may be independently used as flow information, or pieces of the information may be used in combination as flow information. Based on the flow information, packets can be classified into groups.

The process information is an identifier for identifying a process. Examples of the process information include a process identification (ID) of a process for processing a packet, and a process ID of a process for requesting an alternate process. The process information is not limited to such process ID, and any information can be used as long as being an identifier that can unambiguously identify a process in the message processor 100. For example, an identifier indicating a specific process and information uniquely defined within the specific process may be combined and used as an identifier. Specifically, an identifier for specifying IPsec processing (e.g., a protocol number) and a SPI for IPsec may be combined and used as an identifier. When a plurality of identifiers is used, information for specifying types of the identifiers (e.g., values indicating a process ID, IPsec, and a SPI) may be added to the identifiers and managed.

The instruction sequence is an instruction sequence for performing a network process, a specific process for processing data, and other accompanying process sequentially. One example of the specific process is a decryption process of data contained in the form of data in one or more packets received via a network. One example of the accompanying process is a determination process for determining whether received data reaches a size necessary for decryption, though not limited to this. In an instruction sequence field, an instruction sequence itself may be specified, or a memory address at which an instruction sequence is stored may be specified.

The additional information is information that is additionally notified in response to request for an alternate process. Examples of the additional information include an encryption algorithm, and key information used in encryption and decryption. In an additional information field, the additional information itself may be specified, or a memory address at which additional information is stored may be specified.

FIG. 2 depicts an example using, as the flow information, a source IP address (SrcIP), a destination IP address (DstIP), protocol information (Proto), and an identifier (SPI) for identifying a parameter used in a security protocol. Such information is obtained from security association (SA) for IPsec, for example.

SA includes SrcIP=10.0.0.1, DstIP=10.1.1.1, Proto=ESP, SPI=12345, Algo=data encryption standard (DES)-cipher block chaining (CBC), and Key=0x1122334455667788. Algo refers to an encryption algorithm, and Key refers to key information used in the encryption algorithm. In the example shown in FIG. 2, the flow information obtained from such SA is set.

In FIG. 2, a process for processing a received packet is a process for performing IPsec processing. Further, information including: an identifier IPSEC indicating IPsec processing; and an unambiguously defined SPI is used as the process information. Further, the additional information specifies addresses in a buffer where pieces of information specified by Algo and Key of SA are respectively stored.

In the instruction sequence field is set an instruction sequence generated by a generating unit 135. The instruction sequence will be described in detail later.

An entry written to the alternate process management table 121 is deleted when a process identified by the process information is extinguished, when a process no longer requests packet transmission and reception, and when a process detects no packet transmission and reception for a certain length of time. An entry may be deleted in corporation with a process management mechanism of an operating system (OS). For example, when the OS detects extinction of a relevant process, a corresponding entry may be deleted. Alternatively, a dedicated garbage collection may be performed regularly.

Referring back to FIG. 1, the first arithmetic unit 130 is an arithmetic unit representing a main arithmetic unit, and mainly performs a network process related to transmission and reception of a packet. The first arithmetic unit 130 also performs control such as assigning a process to be performed by the second arithmetic unit 140. The first arithmetic unit 130 includes an interrupt processor 131, an identification information detector 132, a packet processor 133, a process detector 134, the generating unit 135, a register unit 136, and a controller 137.

The interrupt processor 131 performs a reception process for receiving a packet, when detecting a hardware interrupt notified by the network I/F unit 110.

The identification information detector 132 detects flow information from a received or transmitted packet. For example, when the network I/F unit 110 receives a packet, the identification information detector 132 detects flow information contained in the received packet.

Specifically, the identification information detector 132 detects flow information, such as a MAC address, an IP address, a TCP port number, and a UDP port number described above, from packet headers corresponding to a data link layer, a network layer, a transport layer, and the like. Alternatively, the identification information detector 132 may detect the flow information from intermediate headers used for forming a tunnel through a virtual private network (VPN). Further, the identification information detector 132 may detect flow information from associated headers such as an encapsulating security payload (ESP) header and an authentication (AH) header of an IPsec packet.

The packet processor 133 performs predetermined packet processing for transmitting and receiving a packet via the network I/F unit 110. For example, the packet processor 133 parses a header portion of a received packet and processes a communication protocol thereof, while creating a header portion of a packet to be transmitted from the network I/F unit 110 and processing a communication protocol thereof.

The process detector 134 detects a process for inputting a packet to be processed in a network process or a process for outputting such packet. Specifically, the process detector 134 detects a process ID of a process using a received packet or of a process creating a packet to be transmitted. The process detector 134 also detects a process requested to be performed by an alternate (an alternate process), and detects a process ID of a process having requested the detected alternate process.

The generating unit 135 determines whether there is a match between a process for inputting or outputting a packet and a process having requested an alternate process, both detected by the process detector 134. If there is a match, the generating unit 135 generates an instruction sequence for sequentially performing the network process and the alternate process. The generating unit 135 determines an execution sequence of the network process and the alternate process detected by the process detector 134, so as to generate an instruction sequence for sequentially performing the processes in the determined execution sequence. For example, the generating unit 135 registers in a memory unit etc. in advance the contents of the network process performed before and after the alternate process, so as to determine an execution sequence of the network process and the alternate process based on the registered information. As in IPsec processing, when the network process to be performed before and after an alternate process is determined in advance, the generating unit 135 may generate an instruction sequence assuming appropriate processes and execution sequence.

An instruction sequence generated by the generating unit 135 will now be described in detail. Although the following describes packet reception as an example, the same method is applicable to packet transmission. The following notations are made for the description:

(1) Im: a process performed inside the interrupt handler, among the network processes performed by the first arithmetic unit 130
(2) Nm: a process performed outside the interrupt handler, among the network processes performed by the first arithmetic unit 130
(3) Ns: a network process performed by the second arithmetic unit 140
(4) P: a process being a recipient of a received packet
(5) Os: an alternate process performed by the second arithmetic unit 140
(6) Ins(*): an instruction sequence corresponding to each of the above processes (any one of Im, Nm, Ns, P, and Os is set for *)

In the first embodiment, assume that two or more instruction sequences are defined in advance that include at least an instruction sequence for a network process, i.e., Ins(Ns), and an instruction sequence for an alternate process, i.e., Ins(Os), and that describe the contents of the alternate process.

Various cases are considered as to whether a network process represented as Ins(Ns) corresponds to any network process within a protocol stack. For example, the whole network processes are regarded as one instruction sequence, or each protocol is regarded as an individual instruction sequence.

The following describes an example that the whole network processes are configured as one instruction sequence. As described above, the instruction sequence Ins(Ns) for performing a network process in the second arithmetic unit 140 is prepared in advance. Ins(Ns) is prepared statically and independently from the process for processing a received packet. For example, when an executable code of a protocol stack to be implemented by the first arithmetic unit 130 is generated by compiling and other operations, an executable code to be executed by the second arithmetic unit 140 is also generated by compiling and other operations. In this way, the instruction sequence Ins(Ns) can be prepared in advance.

Such instruction sequence generated for each process is stored in a form suitable for an execution environment into a memory unit, such as a hard disk drive (not shown), so as to be executable all the time. For example, the instruction sequence can be stored in a form of a dynamically loadable kernel module or dynamic link library. Alternatively, the instruction sequence may be statically embedded in other programs or the like, so as to be expanded in memory when executed.

With the above methods, the instruction sequence for each process can be notified to the second arithmetic unit 140.

Based on such assumption, when finding a match between a process consuming a packet processed in a network process (Nm) and a process having requested the alternate process (Os), the generating unit 135 generates an instruction sequence combining instruction sequences for the processes, i.e., Ins(Ns)|Ins(Os). The symbol “|” indicates combining the instruction sequences. The network process Ns and the network process Nm are basically regarded as the same process except that values to be managed as unambiguous values in a node (e.g., port numbers) are handled differently.

The second arithmetic unit 140 parses the combined instruction sequences, and sequentially executes each of the instruction sequences divided by the symbol ‘|’, starting from the left. The form of the instruction sequences generated by the generating unit 135 is not limited to this, and any form can be applied as long as the second arithmetic unit 140 can sequentially execute the instruction sequences for the respective processes and parse the execution sequence of the instruction sequences. For example, the generating unit 135 may load dynamic link libraries corresponding to the respective instruction sequences to a continuous area in memory, so as to generate an instruction sequence for sequentially performing a plurality of processes. In this case, the second arithmetic unit 140 can perform a plurality of processes sequentially by starting processing at an initial address in the memory where the dynamic link libraries are loaded.

The register unit 136 registers the alternate process information including flow information detected from a packet by the identification information detector 132 and an instruction sequence generated by the generating unit 135, into the alternate process management table 121. For packet reception, the register unit 136 registers therein an entry (alternate process information) including only the flow information and the process information upon receiving a packet, and adds the generated instruction sequence to the registered entry upon performing the alternate process (details will be described later). For packet transmission, the register unit 136 registers therein an entry including only the process information of the process having requested the alternate process, upon performing the alternate process, and adds the flow information and the instruction sequence to the registered entry upon transmitting a packet (details will be described later).

The controller 137 retrieves, from the alternate process management table 121, an instruction sequence corresponding to the flow information detected by the identification information detector 132, so as to control the second arithmetic unit 140 to execute the retrieved instruction sequence as an alternate process.

The second arithmetic unit 140 is an arithmetic unit that performs various processes according to a request etc. from the first arithmetic unit 130. The second arithmetic unit 140 can perform at least a network process Ns and an alternate process Os as described. The second arithmetic unit 140 includes a local memory 141 that stores therein data and the like used for processing in the second arithmetic unit 140, and an arithmetic processor 142 that performs actual computation including an alternate process.

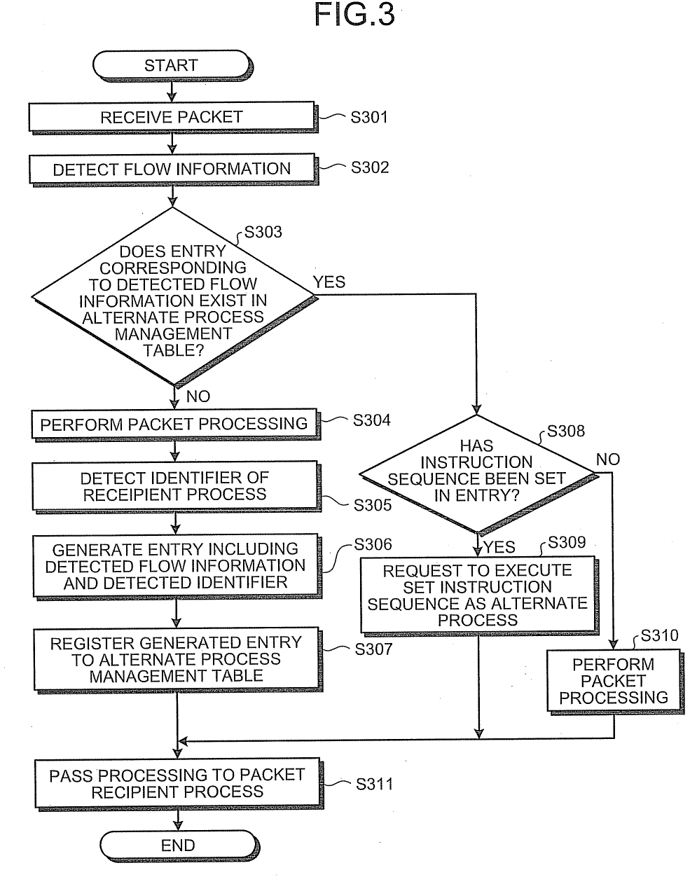

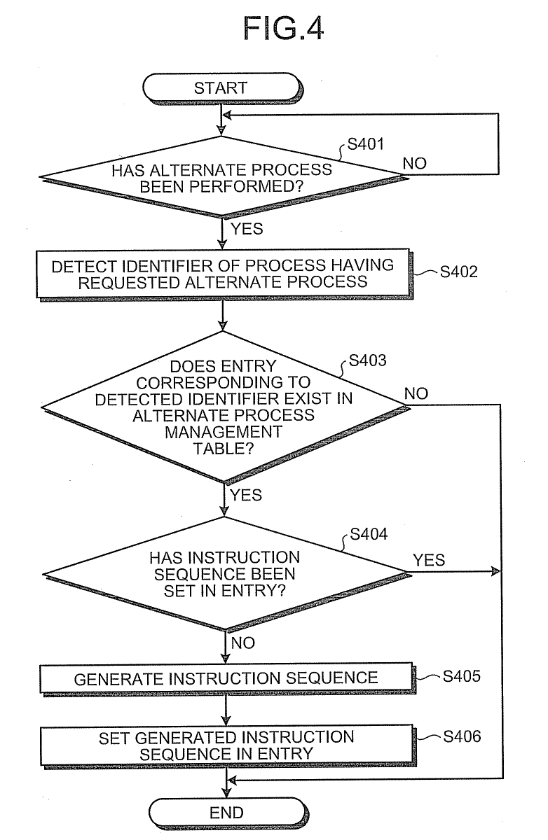

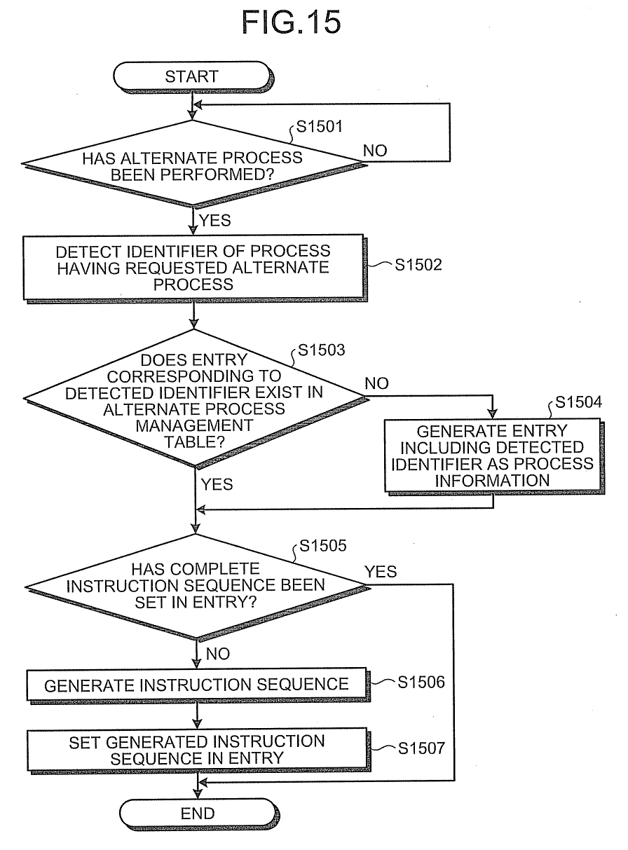

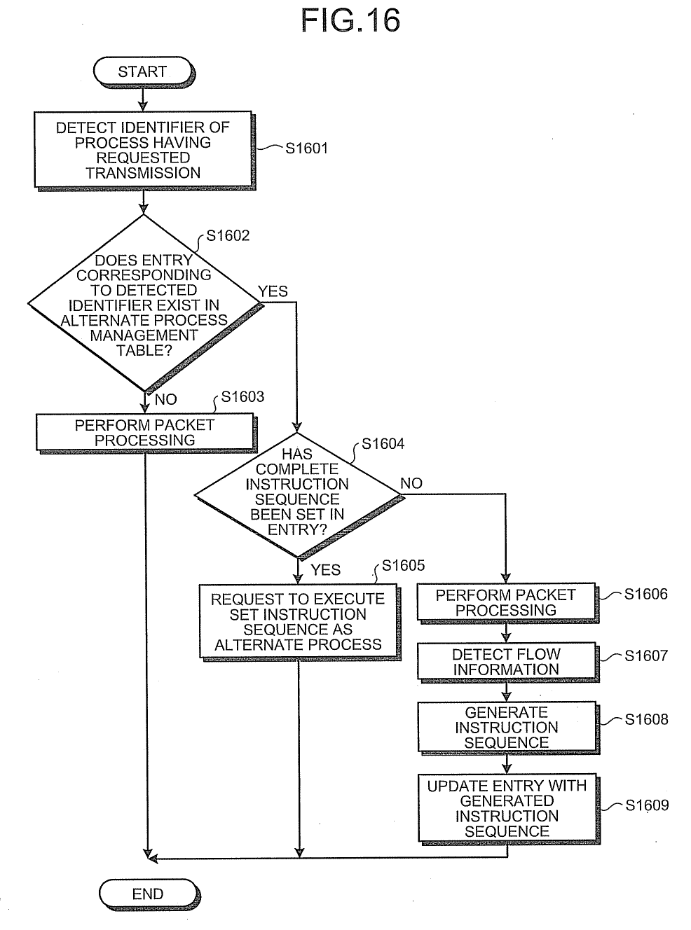

The following describes message processing performed by the message processor 100 having the above configuration according to the first embodiment. The message processing includes a packet reception process for receiving a packet (FIG. 3), and an instruction sequence generation process for generating an instruction sequence by detecting an alternate process upon receiving a packet (FIG. 4). A process for transmitting a packet will be described in detail later (FIGS. 15 and 16).

When a packet reaches the network I/F unit 110, a hardware interrupt is notified, and the interrupt processor 131 is activated. Accordingly, the interrupt processor 131 performs a packet reception process (Step S301).

The identification information detector 132 then detects flow information from the received packet (Step S302). The identification information detector 132 determines whether an entry including the detected flow information has been registered in the alternate process management table 121 (Step S303).

Steps S302 to S303 may be performed in the interrupt processor 131. Specifically, the interrupt processor 131 may detect the flow information and check the entry.

If no entry including the detected flow information has been registered in the alternate process management table 121 (NO at Step S303), the packet processor 133 performs normal packet processing on the received packet (Step S304).

The process detector 134 detects an identifier of a process that receives a packet (hereinafter, “recipient process”) (Step S305). For example, from process management information managed by the OS, the process detector 134 can detect a process ID of the recipient process.

The generating unit 135 generates an entry (alternate process information) including the flow information detected at Step S302 and the process ID detected at Step S305 (Step S306). The generating unit 135 leaves information element(s) not determined yet but to be contained in the entry blank. The register unit 136 registers the generated entry into the alternate process management table 121 (Step S307).

If an entry including the detected flow information has been registered in the alternate process management table 121 (YES at Step S303), the generating unit 135 determines whether an instruction sequence has been set in the entry (Step S308).

If an instruction sequence has been set (YES at Step S308), the controller 137 requests the second arithmetic unit 140 to execute the set instruction sequence as an alternate process (Step S309). For example, the controller 137 makes a request for the alternate process by notifying a memory address at which the received packet is stored and a memory address at which the instruction sequence is stored. The information to be notified with the request for the alternate process is not limited to this. For example, additional information such as a size of a packet(s) processed so far may be notified together. Such additional information is recorded in an additional information field of the alternate process management table 121. After requesting the alternate process, the packet reception process is terminated.

If no instruction sequence has been set in the entry (NO at Step S308), the packet processor 133 performs normal packet processing on the received packet (Step S310).

After Steps S307, S309, and S310, the packet processor 133 passes the processed packet to a recipient process that receives the packet (Step S311), and the packet reception process is terminated. The process receiving the packet can be specified by a port number or the like contained in the packet.

The following describes an instruction sequence generation process for packet reception.

This process is started independently from the packet reception process. For example, this process may be started upon start up of the OS, or upon activation of a device driver that implements an alternate process. Alternatively, this process may be started when a request for an alternate process is made at Step S309 etc. shown in FIG. 3.

The process detector 134 determines whether an alternate process has been performed (Step S401). If no alternate process has been performed (NO at Step S401), the process detector 134 waits until implementation of an alternate process is detected. The process detector 134 stores therein in advance information enabling identification of an alternate process, for example, a dynamic link library name for the alternate process, so as to detect implementation of the alternate process by finding such information contained in the process management information managed by the OS.

If an alternate process has been performed (YES at Step S401), the process detector 134 detects a process ID of a process having requested the alternate process. For example, referring to the process management information managed by the OS, the process detector 134 can detect a process ID of a process having requested the alternate process detected at Step S401.

The generating unit 135 determines whether an entry corresponding to the detected process ID has been registered in the alternate process management table 121 (Step S403). If registered (YES at Step S403), the generating unit 135 further determines whether an instruction sequence has been set in the entry (Step S404).

If no instruction sequence has been set (NO at Step S404), the generating unit 135 generates an instruction sequence for sequentially executing an instruction sequence for the alternate process detected at Step S401 and an instruction sequence for performing a separately stored network process as an alternate process, in an appropriate execution sequence (Step S405). As the execution sequence, such a sequence may be used that has been decided in advance according to the contents of the network process as described, or that is decided by referring to stored information of an execution sequence determined in advance.

When the network process and the alternate process are accompanied by other processes, the generating unit 135 generates an instruction sequence for executing instruction sequences for the accompanying processes in an appropriate execution sequence. The instruction sequences for the accompanying processes can be retrieved by, for example, associating them with instruction sequences for corresponding network processes in advance.

The network process to be performed as an alternate process may be versatile so as to be handled in any process, or may be limited to the contents of the packet processing performed at Step S304 in the packet reception process. In either case, any network process is applicable as long as it includes protocol processing suitable for a packet received via a network.

The register unit 136 sets the generated instruction sequence in a corresponding entry of the alternate process management table 121 (Step S406). For example, the register unit 136 registers the generated instruction sequence into the main memory 120, and registers an address at which the generated instruction sequence is registered, into the entry of the alternate process management table 121.

If no entry corresponding to the detected process ID has been registered in the alternate process management table 121 (NO at Step S403), or if an instruction sequence has been set in the entry (YES at Step S404), the instruction sequence generation process for packet reception is terminated.

This process may be terminated every time an alternate process is detected as shown in FIG. 4, or may go into an infinite loop so as not to be terminated.

Once an instruction sequence is registered to the alternate process management table 121 as shown in the flowchart of FIG. 3, most of the subsequent processes are assigned to the second arithmetic unit 140. This reduces the processing load on the first arithmetic unit 130. Further, the overhead is significantly reduced because not many processes are transferred between dedicated hardware and the first arithmetic unit 130 as in conventional methods. Moreover, the number of times the instruction sequence generation process (shown in FIG. 4) is performed is reduced to the minimum extent necessary, thus causing no major factor in the load.

Advantages achieved by a method according to the first embodiment will now be described. The following describes modifications of the hardware configuration of the message processor 100 according to the first embodiment.

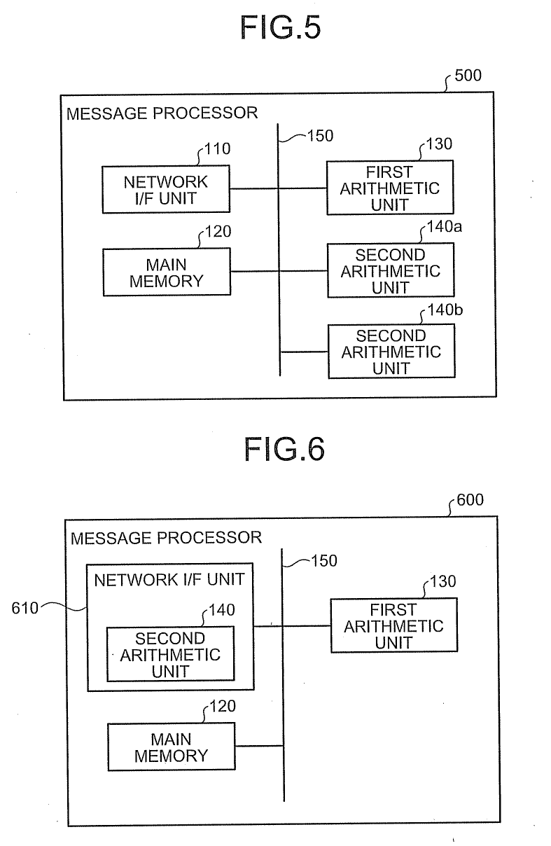

Though one second arithmetic unit 140 is provided in FIG. 1, a plurality of second arithmetic units 140 may be provided. FIG. 5 is a hardware configuration diagram of a message processor 500 having such a configuration. As shown in FIG. 5, the message processor 500 according to this modification includes two second arithmetic units 140a and 140b. For example, each of the second arithmetic units 140a and 140b is configured to perform a unique alternate process determined in advance. Note that three or more second arithmetic units 140 may be provided.

The second arithmetic unit 140 shown in FIG. 1 may be provided in the network I/F unit. FIG. 6 is a hardware configuration diagram of a message processor 600 having such a configuration. As shown in FIG. 6, the message processor 600 according to this modification includes a network I/F unit 610 including the second arithmetic unit 140.

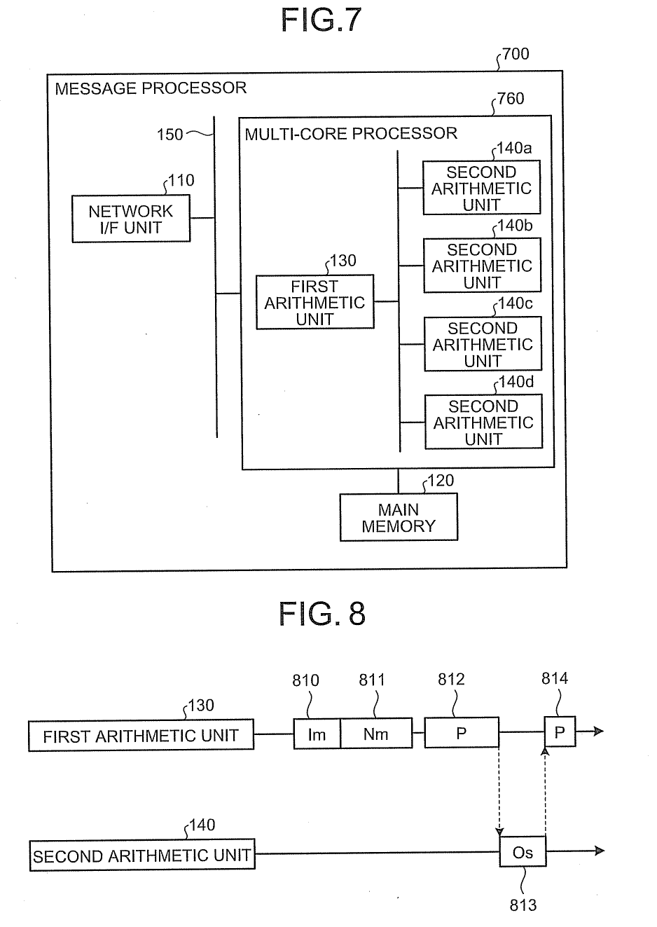

A message processor may employ a multi-core processor including the first arithmetic unit 130 and a plurality of second arithmetic units 140. FIG. 7 is a hardware configuration diagram of a message processor 700 having such a configuration. As shown in FIG. 7, the message processor 700 according to this modification includes a multi-core processor 760 including one first arithmetic unit 130 and four second arithmetic units 140a to 140d. The number of the second arithmetic units 140 is not limited to four, and a plurality of first arithmetic units 130 may be provided.

The message processors shown in FIGS. 5 to 7 are the same as the message processor 100 shown in FIG. 1, except the number and the location of the second arithmetic units 140. Thus, the method applied to the message processor 100 is also applicable to these message processors.

Referring to FIGS. 8 to 10, the following describes an example of message processing performed by a processor having a hardware configuration shown in FIG. 1, 5, or 6, to which the method according to the first embodiment is not applied.

FIG. 8 is a schematic of exemplary processing performed using one first arithmetic unit and one second arithmetic unit. Horizontal arrows indicate a change in time, advancing to the present from left to right. Boxes on the arrows indicate where certain processes are performed. Alphabet(s) in each box indicate a process complied with the above notations.

FIG. 8 depicts a flow of a series of processes triggered by an interrupt that is notified to the first arithmetic unit when the network IF unit receives a packet. The interrupt handler (the interrupt processor 131) of the first arithmetic unit performs a specified process 810 (Im), and then passes the processing to a normal network process 811 (Nm). The network process 811 (Nm) includes a process for specifying a recipient process. Accordingly, a process 812 (P) is performed as a subsequent process.

The recipient process is implemented so as to perform a process 813 (Os) as an alternate process during the processing. Thus, the process 813 (Os) is performed in the second arithmetic unit during the processing. Upon completion of the process 813 (Os), the processing is returned to the first arithmetic unit and the rest of the recipient process, i.e., a process 814 (P), is started again. To execute the sequence shown in FIG. 8, an instruction sequence Ins(Os) for operating the second arithmetic unit is prepared in advance as an executable program code.

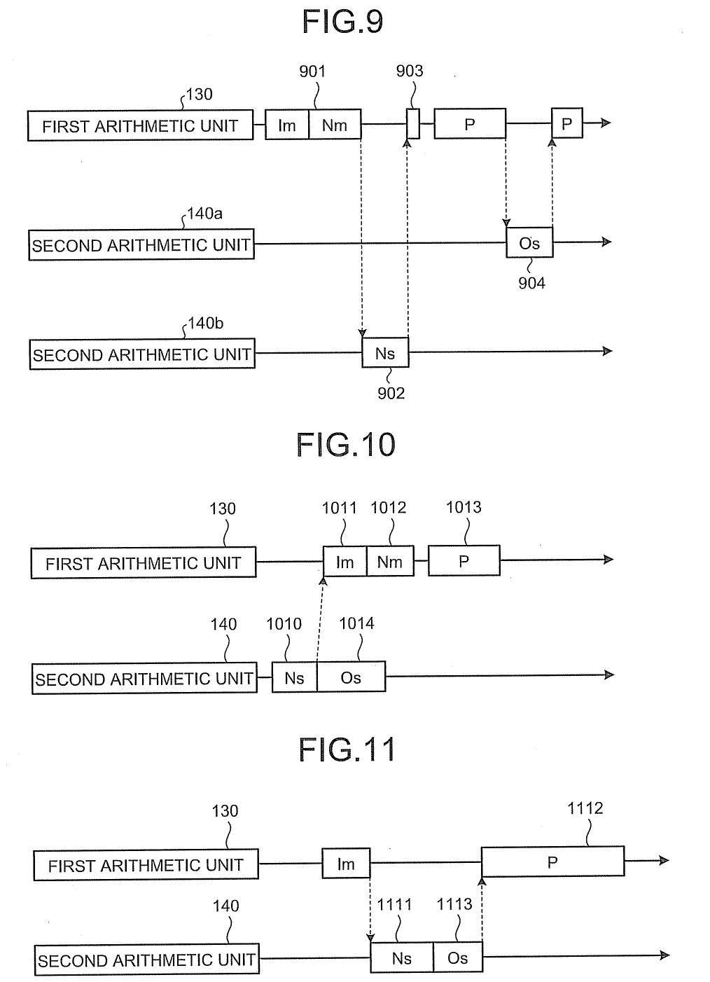

FIG. 9 is a schematic of exemplary processing performed using one first arithmetic unit and two second arithmetic units as shown in FIG. 5. In this example, after a network process 901 (Nm), a portion of the network process, i.e., a process 902 (Ns), is performed by one of the second arithmetic units as an alternate process. A process 903 is the rest of the network process. In this example, a process 904 (Os) is performed by the other second arithmetic unit as an alternate process. To execute the sequence shown in FIG. 9, the instruction sequences Ins(Ns) and Ins(Os) for operating the second arithmetic units are prepared in advance as executable program codes.

FIG. 10 is a schematic of exemplary processing performed using one first arithmetic unit, and one second arithmetic unit provided in the network I/F unit as shown in FIG. 6. In this example, because the second arithmetic unit is implemented on the network I/F unit, a network process 1010 (Ns) and an alternate process 1014 (Os), both in the second arithmetic unit, are performed sequentially.

Upon completion of the network process 1010 (Ns), a process 1011 (Im) is performed by the interrupt handler (the interrupt processor 131) in the first arithmetic unit. Thereafter, a network process 1012 (Nm) is performed to the minimum extent necessary. The result of the alternate process 1014 (Os) performed in advance is used in a process 1013 (P) performed at last.

In the examples shown in FIGS. 8 and 9, performing an alternate process between processes causes a problem of increasing the overhead due to the complex processes and data movement. Compared with the methods shown in FIGS. 8 and 9, the example shown in FIG. 10 is effective because no alternate process is performed between processes. The configuration shown in FIG. 6 realizing the method shown in FIG. 10, however, requires a dedicated network I/F unit including the second arithmetic unit.

According to the first embodiment, without such dedicated network I/F unit, use of only versatile arithmetic units can prevent an increase in processing load when another arithmetic unit performs, as an alternate process, the process to be performed by the main arithmetic unit. FIG. 11 depicts an example that the second arithmetic unit 140 sequentially performs a network process 1111 (Ns) and an alternate process 1113 (Os) by using an instruction sequence registered to the alternate process management table 121. Compared with the method shown in FIG. 8, the method shown in FIG. 11 performs the alternate process 1113 (Os) in advance, and accordingly performs a process 1112 (P) as a recipient process without interruption. Thus, according to the first embodiment, without dedicated hardware, it is possible to prevent an increase in the overhead when another arithmetic unit performs, as an alternate process, the process to be performed by the main arithmetic unit.

A specific example of message processing according to the first embodiment will now be described. The following describes an example that a network process for receiving a packet, and symmetric-key encryption at a secure socket layer (SSL) for decrypting a received packet are performed as alternate processes. The second arithmetic unit 140 is predetermined to perform, as an alternate process, computation of an encryption algorithm necessary for the symmetric-key encryption at the SSL.

The packet reception process is started when the network I/F unit 110 of the message processor 100 receives a packet at a given timing. Assume that the received packet contains flow information including a source IP address=“10.2.2.1”, a destination IP address=“10.2.2.2”, a protocol=“TCP”, a source port number=“80”, and a destination port number=“54321”.

When the packet reaches the network I/F unit 110, an interrupt signal is notified to the first arithmetic unit 130. Accordingly, the interrupt processor 131 is activated in the first arithmetic unit 130. After the interrupt processor 131 performs an appropriate process (Step S301), the identification information detector 132 extracts the flow information from the packet, so as to detect an entry, corresponding to the extracted flow information, in the alternate process management table 121 (Steps S302 and S303). Because the packet containing the above flow information is received for the first time, no entry exists yet in the alternate process management table 121. Thus, the packet processor 133 performs normal packet processing (Step S304).

During the packet processing, a process for eventually consuming the packet is decided. The generating unit 135 generates an entry in the alternate process management table 121, with a process ID of a decided process and the detected flow information (Step S306). The register unit 136 registers the generated entry to the alternate process management table 121 (Step S307). Upon completion of the registration, a first stage of the packet reception process is terminated.

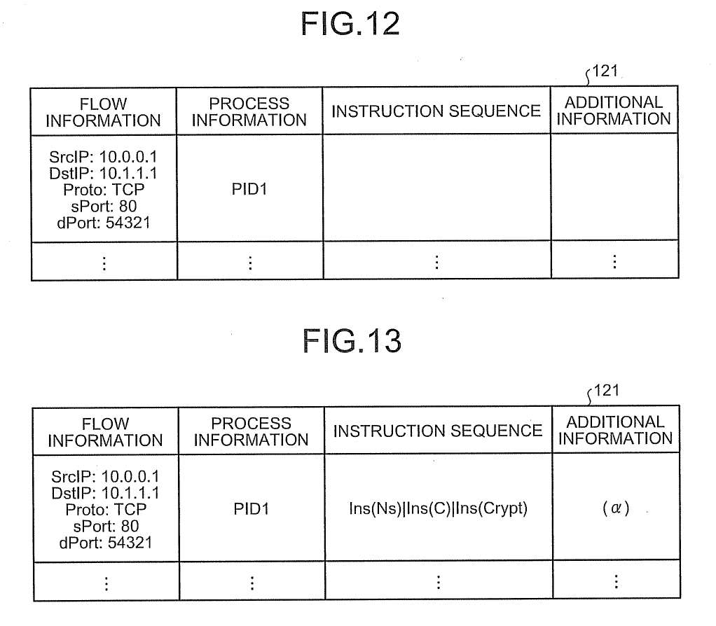

FIG. 12 is a diagram of an exemplary entry registered in the alternate process management table 121 at this stage. In a flow information field is described the detected flow information. In a process information field is described “PID1” indicating the process ID of the decided process. The other two fields are left blank because no information is defined yet at this stage.

Assume that the received packet is passed to the process that eventually consumes the packet. This process checks whether a sufficient amount of data for enabling the processing at the SSL has been received. Assume that not sufficient amount of data has been received. In this case, the process waits again until another packet is received.

Further, assume that a packet belonging to a flow indicated by the flow information reaches the network I/F unit 110. In the same manner as described, the interrupt processor 131 receives the packet (Step S301), and the identification information detector 132 checks an entry corresponding to the flow information (Steps S302 and S303). Because the entry has been generated in the above processes, determination is made that the entry exists in the alternate process management table 121 (YES at Step S303).

In this case, the generating unit 135 determines whether an instruction sequence has been set in the detected entry (Step S308). As shown in FIG. 12, determination is made that no instruction sequence has been described in the entry (NO at Step S308). Thus, the packet processor 133 performs normal packet processing (Step S310).

Assume that, again, the received packet is passed to the process that eventually consumes the packet. This process determines the length of data having been received but not processed yet. Assume that a sufficient amount of data for enabling the processing at the SSL has been received.

Because receiving data necessary for decryption is confirmed, the process attempts to decrypt the encrypted data. This process is set in advance to be performed in the second arithmetic unit 140 as an alternate process. Thus, the process makes a request for the alternate process by notifying an instruction sequence for the alternate process and input data to the second arithmetic unit 140.

The request for the alternate process, made by the process, is captured at Step S401 in the instruction sequence generation process shown in FIG. 4. When the request for the alternate process is captured (YES at Step S401), the process detector 134 specifies the process having requested the alternate process (Step S402). Assume that the process ID=“PID1” is acquired.

The generating unit 135 detects an entry, corresponding to the acquired process ID, in the alternate process management table 121 (Step S403). As shown in FIG. 12, an entry including the process information “PID1” exists in the alternate process management table 121.

The generating unit 135 determines whether an instruction sequence has been set in the entry (Step S404). If an instruction sequence has been described (YES at Step S404), the instruction sequence generation process is terminated because there is no need to generate a new instruction sequence. Because no instruction sequence has been described yet as shown in FIG. 12 (NO at Step S404), the generating unit 135 generates an instruction sequence.

For example, the generating unit 135 generates an instruction sequence “Ins(Ns)|Ins(C)|Ins(Crypt)”. Ins(Ns) is an instruction sequence for a network process to be performed in the second arithmetic unit 140. Ins(Crypt) is an instruction sequence for implementing an encryption algorithm that has been notified to the second arithmetic unit 140 along with the request for the alternate process.

Ins(C) is an instruction sequence for a process that determines the size of received data. Ins(C) receives an input of a threshold a indicating the size of received data and used to determine whether Ins(Crypt) is executable, and an input of a total amount β of data processed in Ins(Ns) but not processed in Ins(Crypt). When β is greater than α, Ins(C) determines that Ins(Crypt) is executable.

The threshold α is defined in advance according to the encryption algorithm to be implemented, and is notified to the second arithmetic unit 140 when the controller 137 requests the second arithmetic unit 140 to execute the instruction sequence. The controller 137 may detect and store therein in advance the size of data passed to the process that implements the encryption algorithm, so as to notify the stored size as the threshold a to the second arithmetic unit 140.

When the instruction sequence is generated, the register unit 136 updates the relevant entry with the generated instruction sequence (Step S406). Concurrently, the register unit 136 writes the threshold α in the additional information field of the entry. The alternate process requested by the process may actually be performed during the instruction sequence generation process or upon completion thereof.

FIG. 13 is a diagram of an exemplary entry registered in the alternate process management table 121 at this stage. As shown in FIG. 13, the generated instruction sequence and the threshold α are added in the instruction sequence field and the additional information field, respectively.

Assume that another packet belonging to the same flow is further received. In this case, the packet reception process shown in FIG. 3 is performed. The entry corresponding to the detected flow information exists (YES at Step S303), and the instruction sequence has been described (YES at Step S308). Thus, a request is made for executing, as an alternate process, the instruction sequence described in the entry (Step S309).

The instruction sequence requested for the alternate process is “Ins(Ns)|Ins(C)|Ins(Crypt)” as described. Because only one packet has been received, the data size is small. Thus, Ins(C) determines that Ins(Crypt) is not executable, and the alternate process is terminated.

Assume that another packet belonging to the same flow is further received and Ins(C) determines that a sufficient amount of data has been received. In this case, the subsequent process Ins(Crypt) is performed. A result of a network process performed on the packet first received is registered in a memory area directly accessible by the second arithmetic unit 140, so that, together with the registered result, a result of a network process performed on the packet subsequently received is processed in Ins(Crypt).

Another specific example of message processing according to the first embodiment will now be described. The following describes an example of applying the message processor 700 including the multi-core processor 760 as shown in FIG. 7.

A message processing program that performs message processing is registered in an executable program format in the main memory 120. The message processing program is loaded to the multi-core processor 760 and executed depending on the situation.

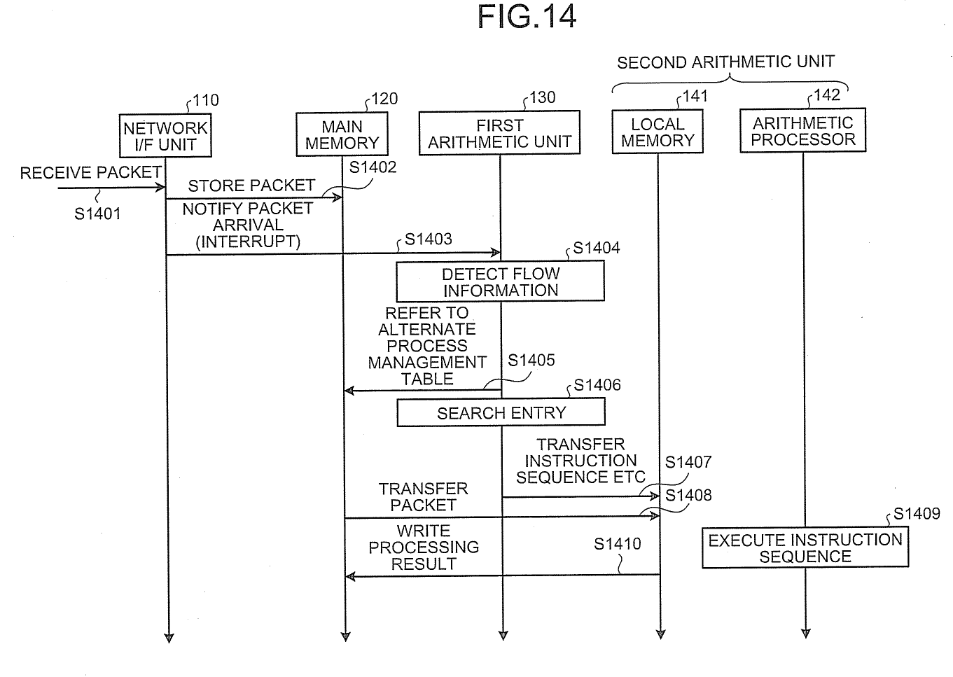

FIG. 14 is a schematic sequence diagram of message processing in this example. When a packet reaches the network I/F unit 110 (Step S1401), the network I/F unit 110 stores the received packet in the main memory 120 (Step S1402). The network I/F unit 110 also notifies an interrupt to the first arithmetic unit 130 of the multi-core processor 760 (Step S1403).

The first arithmetic unit 130 loads a code of the interrupt handler (the interrupt processor 131) from the main memory 120, and executes the code. In the same manner as described, the identification information detector 132 performs processing, so as to detect flow information from the received packet (Step S1404).

Thereafter, the first arithmetic unit 130 refers to the alternate process management table 121 stored in the main memory 120 (Step S1405), and checks whether an entry corresponding to the received packet exists and whether an instruction sequence exists in the entry (Step S1406). The first arithmetic unit 130 also refers to the contents of the packet stored in the main memory 120 as necessary. If no corresponding entry or instruction sequence exits, the first arithmetic unit 130 continues the processing.

Assume that both the entry and the instruction sequence exist. The first arithmetic unit 130 stores, in the local memory 141 of the second arithmetic unit 140, the instruction sequence and additional information, both described in the corresponding entry, and an address in the main memory 120 where the packet is stored (Step S1407). The first arithmetic unit 130 then requests the arithmetic processor 142 of the second arithmetic unit 140 to perform the processing.

The second arithmetic unit 140 refers to the address of the packet described in the local memory 141, and transfers the packet from the main memory 120 to the local memory 141 (Step S1408). The second arithmetic unit 140 then performs processing according to the instruction sequence stored in the local memory 141 (Step S1409). Upon completion of the processing, the second arithmetic unit 140 may write a computational result back to the main memory 120 (Step S1410), or may transfer a computational result to the local memory 141 of the other second arithmetic unit 140, as necessary.

The foregoing mainly describes an alternate process for packet reception. The same process is applicable to packet transmission. The following describes in detail message processing for packet transmission. The message processing for packet transmission includes an instruction sequence generation process for generating an instruction sequence by detecting an alternate process during packet transmission (FIG. 15), and a packet transmission process for transmitting a packet (FIG. 16).

Alternate process detection, process ID detection, and entry detection at Steps S1501 to S1503 are the same as those at Steps S401 to S403 of the instruction sequence generation process for packet reception shown in FIG. 4, and descriptions thereof are omitted.

For packet transmission, an alternate process is performed before a network process. As to an alternate process performed for the first time, no corresponding entry exists in the alternate process management table 121. When no entry corresponding to the detected process ID has been registered in the alternate process management table 121 (NO at Step S1503), an entry creation process is added (Step S1504). Specifically, the generating unit 135 generates an entry including the detected process ID as process information (Step S1504), and the register unit 136 registers the generated entry in the alternate process management table 121. Because no information other than the process information can be specified at this stage, the other fields are left blank.

If an entry corresponding to the detected process ID has been registered in the alternate process management table 121 (YES at Step S1503), the generating unit 135 determines whether a complete instruction sequence has been set in the entry (Step S1505). The complete instruction sequence is an instruction sequence for performing a network process and one or more alternate processes.

If a complete instruction sequence has been set (YES at Step S1505), the instruction sequence generation process for packet transmission is terminated because there is no need to generate an instruction sequence. If no complete instruction sequence has been set (NO at Step S1505), the generating unit 135 generates an instruction sequence (Step S1506). The instruction sequence generated at Step 1506 is in two forms.

The instruction sequence of a first form includes no network process for transmission (transmission network process). For example, when an alternate process is performed for the first time and an entry is then registered at Step S1504, the contents of a network process for transmission have not been defined yet. Thus, the generating unit 135 generates a temporal instruction sequence that includes only an instruction sequence for the alternate process, without an instruction sequence for a transmission network process. The temporal instruction sequence is combined with an instruction sequence for a transmission network process at Step S1608 shown in FIG. 16 (described later), so as to become a complete instruction sequence.

The instruction sequence of a second form is a complete instruction sequence including a transmission network process. For example, when communication is started but a transmission process is sequentially performed not as an alternate process, an entry can be generated in advance. In this case, the generating unit 135 is able to generate a complete instruction sequence that includes a generated instruction sequence for a transmission network process and an instruction sequence for an alternate process.

Finally, the register unit 136 sets the generated instruction sequence in a corresponding entry of the alternate process management table 121 (Step S1507), and the instruction sequence generation process for packet transmission is terminated.

Referring to FIG. 16, the following describes a packet transmission process.

The process detector 134 detects a process ID of a process having requested packet transmission (Step S1601). The process detector 134 then determines whether an entry including the detected process ID has been registered in the alternate process management table 121 (Step S1602).

If no entry including the detected process ID has been stored (NO at Step S1602), the packet processor 133 performs normal packet processing on a packet to be transmitted (Step S1603), and the packet transmission process is terminated.

If an entry including the detected process ID has been stored (YES at Step S1602), the generating unit 135 determines whether a complete instruction sequence has been set in the entry (Step S1604). If a complete instruction sequence has been set (YES at Step S1604), the controller 137 requests the second arithmetic unit 140 to execute the set instruction sequence as an alternate process (Step S1605), and the packet transmission process is terminated.

If no complete instruction sequence has been set in the entry (NO at Step S1604), the packet processor 133 performs normal packet processing on a received packet (Step S1606). The identification information detector 132 detects flow information from the transmitted packet (Step S1607). Then, the generating unit 135 generates a complete instruction sequence combining a temporal instruction sequence in the entry (an instruction sequence for an alternate process), and an instruction sequence for a transmission network process (Step S1608). Accordingly, the register unit 136 updates the alternate process management table 121 with the entry including the generated instruction sequence and the detected flow information (Step S1609).

As described, the packet transmission process differs from the packet reception process shown in FIG. 3, with regard to the following:

(1) When an entry exists in the alternate process management table 121 and no complete instruction sequence has been registered (NO at Step S1604), a network process (normal transmission process) and updating of the entry are performed;
(2) No portion exists that is operated in the interrupt handler (the interrupt processor 131);
(3) If no entry exists in the alternate process management table 121 (NO at Step S1602), normal network processing is performed; and
(4) Subsequent to the transmission process, a process is added for detecting flow information of a packet to be transmitted (Step S1607).

A specific example of message processing for packet transmission according to the first embodiment will now be described. The following describes an example that a packet encrypted at the SSL is transmitted to the network. Computation of an encryption algorithm necessary for the symmetric-key encryption at the SSL is predetermined to be performed in the second arithmetic unit 140 as an alternate process.

To begin with, a process generates data to be transmitted via a network. The data is now in the main memory 120, and encrypted before being transmitted to the network. Because the data is to be encrypted in the second arithmetic unit 140 as an alternate process, the process notifies an instruction sequence for the encryption and an address of the data to the second arithmetic unit 140.

The second arithmetic unit 140 loads the data to the local memory 141, and encrypts it. Triggered by the notification, the first arithmetic unit 130 executes the instruction sequence generation process (FIG. 15).

Because the alternate process (the encryption) is performed for the first time in this example, an entry including a temporal instruction sequence that includes an instruction sequence for the encryption is added to the alternate process management table 121 (Steps S1506 and S1507). Upon completion of the encryption, the data on the local memory 141 of the second arithmetic unit 140 is written to the main memory 120.

After all the data is encrypted, the packet transmission process (FIG. 16) is performed. In this example, because the entry including the temporal instruction sequence has been registered to the alternate process management table 121 (YES at Step S1602, NO at Step S1604), a normal transmission network process is performed (Step S1606). Then, flow information is detected (Step S1607), an instruction sequence is generated (Step S1608), and the entry is updated (Step S1609). Accordingly, the packet transmission process is complete.

The packet transmission process is performed in the first arithmetic unit 130. The data stored in the main memory 120 is transmitted from the main memory 120 to a network via the network I/F unit 110, when the transmission network process (Step S1606) is performed.

Assume that the process further generates subsequent data. Then, when the process attempts to encrypt the data, the instruction sequence generation process (FIG. 15) is started again. Because the entry including the complete instruction sequence has been registered to the alternate process management table 121 (YES at Step S1503, YES at Step S1505), the instruction sequence generation process is terminated without performing a specific process. In this example, the data is not processed, and necessary information including a process area is stored in the entry of the alternate process management table 121.

Subsequent to the instruction sequence generation process, the packet transmission process (FIG. 16) is performed. Because the entry including the complete instruction sequence has been registered to the alternate process management table 121 (YES at Step S1602, YES at Step S1604), the second arithmetic unit 140 is requested to perform an alternate process (Step S1605). Together with the instruction sequence and the address at which the data is stored, information of the process area stored in the instruction sequence generation process (FIG. 15) is notified to the second arithmetic unit 140.

Upon receipt of the notification, the second arithmetic unit 140 loads the data to the local memory 141, encrypts the data in the notified area, and transmits it to the network. In this way, the second arithmetic unit 140 sequentially performs encryption and a transmission network process that are not performed in the instruction sequence generation process (FIG. 15).

As such, an alternate process and a network process can be performed sequentially for packet transmission, as well as for packet reception. This prevents an increase in processing load when another arithmetic unit performs an alternate process.

In the foregoing description, the generating unit 135 automatically combines an instruction sequence for a network process (Ins(Ns)) and an instruction sequence for an alternate process (Ins(Os)), thereby generating an instruction sequence for performing the both processes sequentially. The execution environment, however, affects whether the second arithmetic unit 140 can sequentially perform the process Ns and the process Os on the same data by using the instruction sequence automatically combining Ins (Ns) and Ins (Os).

When the second arithmetic unit 140 cannot execute the instruction sequence automatically combining the processes, an instruction sequence may be used that is represented in tabular form as below. In this modification, the second arithmetic unit 140 includes a program loader for parsing and executing the instruction sequence. The program loader uses an executable code address table for instruction sequences each including pieces of information that can identify instruction sequences for respective processes, an execution sequence of the processes, and addresses of input data and of output data for each of the processes. The executable code address table associates the information that can identify instruction sequence.

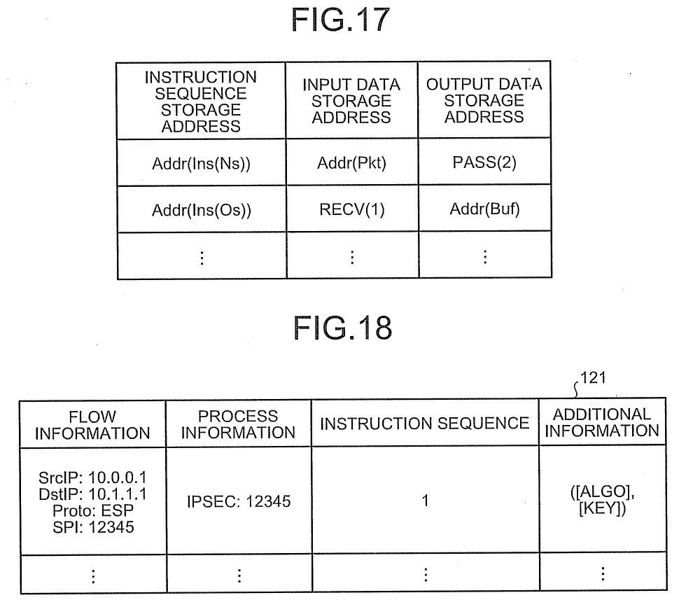

As shown in FIG. 17, in the executable code address table is stored a plurality of entries each including an address at which an executable instruction sequence is stored (an instruction sequence storage address), an address at which input data is stored (an input data storage address), and an address at which output data is to be stored (an output data storage address). The entry associate the address at which an executable instruction sequence is stored, the address at which input data is stored, and the address at which output data is to be stored. FIG. 17 depicts an example of the executable code address table showing instruction sequences to be executed in sequence from the top entry on the table. In each entry, sequence information indicating an execution sequence may be stored, so that the instruction sequences may be executed according to the sequence information.

In the example shown in FIG. 17, output data for an instruction sequence of the initial entry is used as input data for an instruction sequence of the next entry, as indicated by the information set in an output data storage address of the first entry and in an input data storage address of the next entry. Specifically, PASS(2) is set in the output data storage address of the first entry, and RECV(1) is set in the input data storage address of the next entry.

PASS(n) indicates that output data is passed to a process corresponding to an instruction sequence of n-th entry as input data. RECV(n) indicates that output data for a process corresponding to an instruction sequence of n-th entry is received as input data. In this case, data may be passed via a predetermined register, for example.

Without using PASS and RECV, the addresses in the main memory 120 may be described in the input data storage address and the output data storage address.

In the example of the executable code address table shown in FIG. 17, the network process Ns and the alternate process Os are combined into one process, and performed in the second arithmetic unit 140. Addr(Ins(Ns)) is an address at which an instruction sequence Ins(Ns) for the network process Ns is stored, and Addr(Pkt) is an address at which a received packet is stored. Similarly, Addr(Ins(Os)) is an address at which an instruction sequence Ins(Os) is stored, and Addr(Buf) is an address in a buffer storing therein a processing result.

When the program loader is implemented in the second arithmetic unit 140, the program loader executes an instruction sequence in a sequence described in the executable code address table. The program loader loads input data for each instruction sequence from the input data storage address, and stores output data, i.e., a processing result of each instruction sequence, into the output data storage address. Upon completing the above operations for all the entries, the program loader terminates the processing. In this way, the alternate processes in a string of the processing are complete.

When an instruction sequence is generated in the form of an executable code address table, for example, a table ID for identifying an executable code address table is set in the instruction sequence field of the alternate process management table 121. As shown in FIG. 18, a table ID for identifying an executable code address table, as shown in FIG. 17, is set in the instruction sequence field.

The method for generating an instruction sequence is not limited to the method automatically combining a plurality of instruction sequences, or to the method for generating an instruction sequence in tabular form, such as in an executable code address table. Any method is applicable as long as it generates an instruction sequence for enabling sequential execution of instruction sequences for a network process and an alternate process.

As such, a message processor according to the first embodiment detects an alternate process (a specific process) to be performed in the second arithmetic unit in relation with a network process performed in the first arithmetic unit, dynamically generates an instruction sequence for sequentially performing the network process and the specific process, and stores it in a memory unit. This allows the second arithmetic unit to use the stored instruction sequence to perform the network process and the specific process sequentially on a packet to be processed thereafter. In this way, a primary object of preventing an increase in loads on the main processor is achieved, while reducing the overhead due to the complex processes and data movement.

According to the first embodiment, a network process and a related alternate process are detected, so that an instruction sequence is dynamically generated and used. In a message processor according to a second embodiment of the present invention, an instruction sequence can be registered in advance according to a request from a process, and the second arithmetic unit performs a plurality of processes sequentially using the instruction sequence registered in advance.

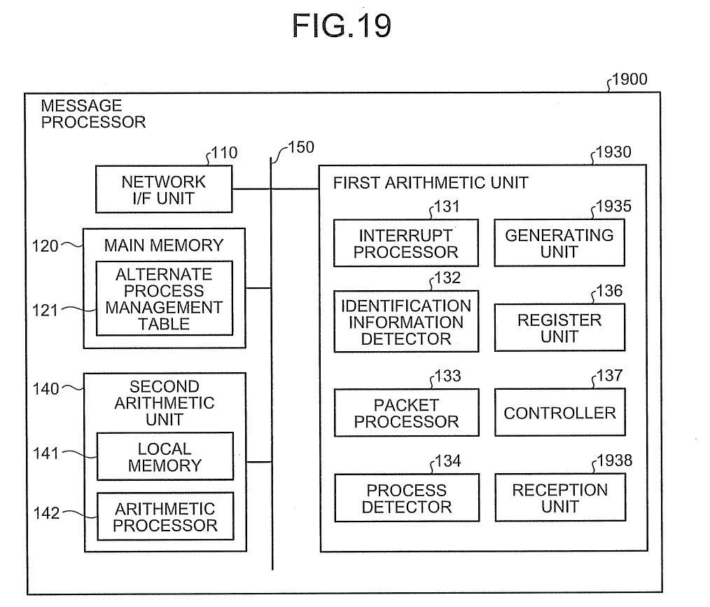

As shown in FIG. 19, a message processor 1900 includes the network I/F unit 110, the main memory 120, a first arithmetic unit 1930, the second arithmetic unit 140, and the bus 150.

The second embodiment differs from the first embodiment with regard to a reception unit 1938 added to the first arithmetic unit 1930 and functions of a generating unit 1935. The other configuration and functions are the same as those of the message processor 100 according to the first embodiment, shown in the block diagram of FIG. 1. Thus, the same reference numerals are used and descriptions thereof are omitted.

The reception unit 1938 receives, from the process for receiving a packet or the process for creating a packet to be transmitted, a registration request for registering an instruction sequence including flow information of the packet, and process identification information for identifying a specific process to be performed on a packet that belongs to a flow identified by the flow information.

The generating unit 1935 generates an instruction sequence for sequentially performing a specific process identified by the process identification information contained in the received registration request, and the network process.

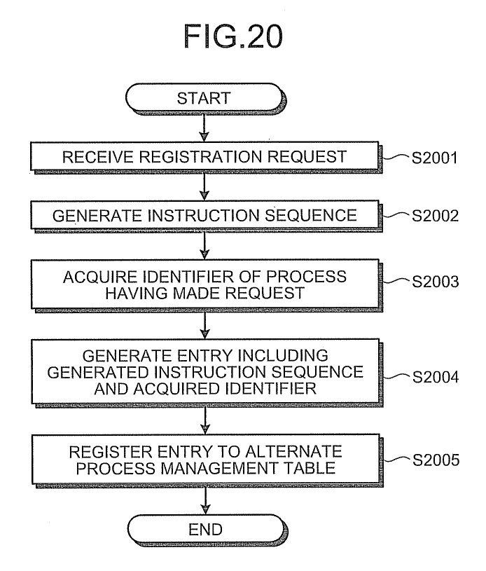

Referring to FIG. 20, the following describes an instruction sequence generation process performed by the message processor 1900 having the above configuration according to the second embodiment.

In the first embodiment, the instruction sequence generation process differs between packet reception (FIG. 4) and packet transmission (FIG. 15) because an instruction sequence is dynamically generated to receive or transmit a packet. In the second embodiment, only the instruction sequence generation process shown in FIG. 20 is performed because an instruction sequence is generated in advance, prior to execution of a network process, according to a request from the process.

The reception unit 1938 receives the registration request for registering an instruction sequence, from the process for receiving a packet or the process for transmitting a packet (Step S2001). The registration request includes flow information of the packet, and process identification information for identifying a specific process to be performed on the packet. Information to be determined through communications, such as an IP address, a TCP port number, and a UDP port number, need not be notified as the flow information.

Upon receipt of the registration request, the generating unit 1935 generates an instruction sequence for sequentially performing a plurality of processes, by combining an instruction sequence for a network process prepared in advance, an instruction sequence for a specific process that is identified by the process identification information contained in the registration request, and an instruction sequence for an accompanying process (Step S2002).

The reception unit 1938 may receive sequence information indicating an execution sequence of the network process, the specific process, and the accompanying process from the process, so that the generating unit 1935 may generate an instruction sequence for performing the processes according to the received sequence information.

The process detector 134 acquires a process ID of the process having transmitted the registration request (Step S2003). The generating unit 1935 generates an entry including the flow information contained in the registration request, the generated instruction sequence, and the detected process ID, the entry associating the flow information, the generated instruction sequence, and the detected process ID (Step S2004). The register unit 136 registers the generated entry to the alternate process management table 121 (Step S2005), and the instruction sequence generation process is terminated.

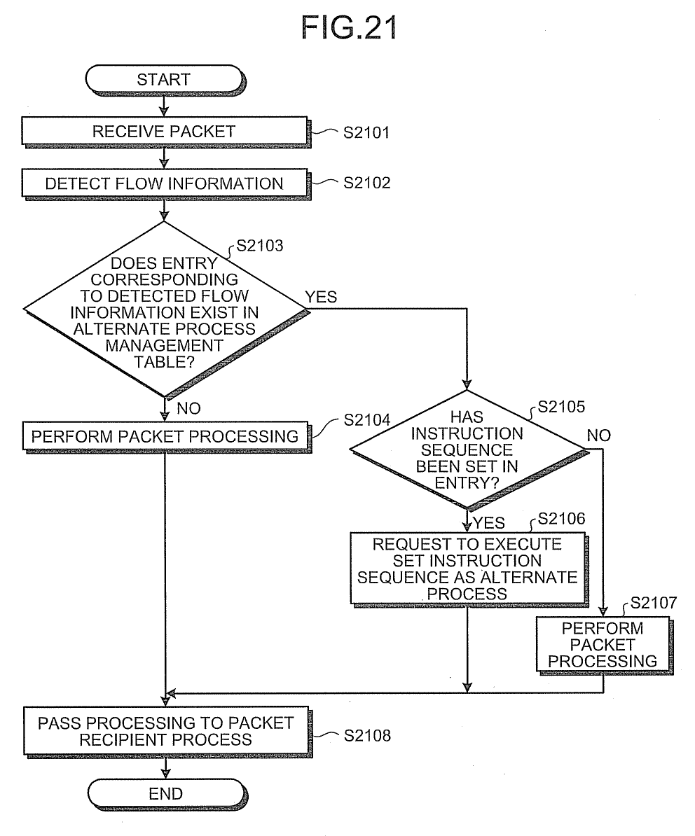

Referring to FIG. 21, the following describes a packet reception process according to the second embodiment.

Compared with the packet reception process according to the first embodiment shown in FIG. 3, FIG. 21 differs in that the process for creating an entry in the alternate process management table 121 (Steps S305 to S307) subsequent to packet reception is deleted. This is because the contents to be processed as an alternate process are notified in advance and accordingly an entry is generated in advance. Thus, there is no need to generate an entry upon receiving a packet. The other steps are the same as those shown in FIG. 3, and descriptions thereof are omitted.

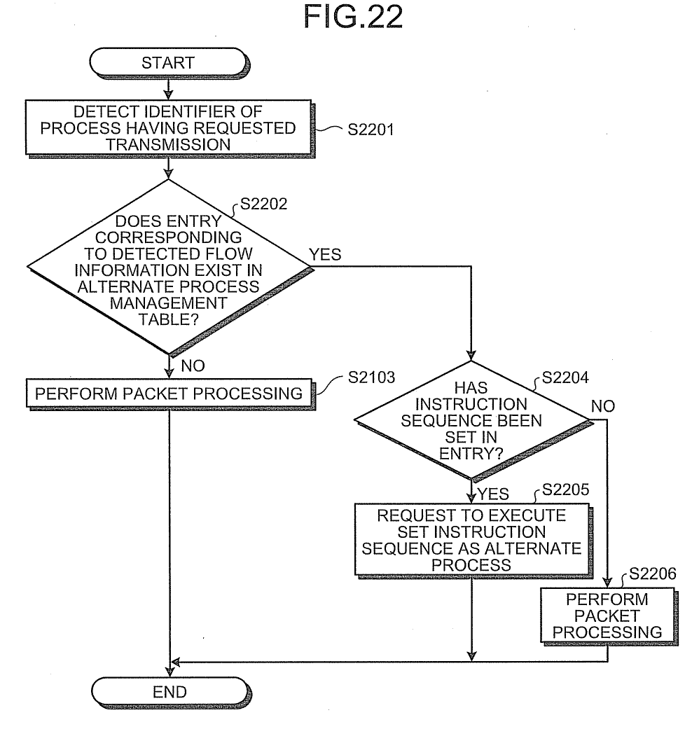

Referring to FIG. 22, the following describes a packet transmission process according to the second embodiment.

As in the packet reception process, compared with the packet transmission process according to the first embodiment shown in FIG. 16, FIG. 22 differs in that the entry creation process (Steps S1607 to S1609) is deleted. The other steps are the same as those shown in FIG. 3, and descriptions thereof are omitted.

A specific example of message processing according to the second embodiment will now be described. The following describes an example that a network process for receiving a packet and IPsec encryption are performed as alternate processes. Computation of an encryption algorithm necessary for IPsec processing is predetermined to be performed in the second arithmetic unit 140 as an alternate process.

To apply IPsec, an Ipsec SA is established in advance between devices communicating with each other. Information of the SA is conveyed to the packet processor 133, so that the instruction sequence generation process (FIG. 20) is performed accordingly. Specifically, when a registration request including, as flow information, information for establishing an IPsec SA is notified (Step S2001), a corresponding instruction sequence is generated (Step S2002). Then, an entry including the generated instruction sequence is generated and registered to the alternate process management table 121 (Steps S2004 and S2005).

In this example, the generated instruction sequence is “Ins(Ns)|Ins(Crypt)|Ins(N2s)” for sequentially performing network processes Ns and N2s prepared in advance, and an encryption algorithm process Crypt predetermined as an alternate process. Ns is a network process to be performed before the encryption algorithm process, and N2s is a network process to be performed after completion of the encryption algorithm process.

Because the IPsec processing is to be performed between the network processes, an instruction sequence needs to be generated adhering to this sequence. To this end, information for identifying the network process to be performed before the alternate process and information for identifying the network process to be performed after the alternate process may be notified along with the flow information. If such information is notified, the generating unit 1935 generates an instruction sequence adhering to a specified sequence.

When the entry is added to the alternate process management table 121 and the SA is properly established, the packet encrypted using IPsec can be received. A specific example of a packet reception process according to the second embodiment will now be described, regarding reception of a packet conforming to the established SA. Assume that an entry as shown in FIG. 2 is added to the alternate process management table 121.

When a packet encrypted using IPsec reaches the network I/F unit 110, an interrupt signal is transmitted to the first arithmetic unit 1930. Triggered by this, the packet reception process (FIG. 21) is started.

The first arithmetic unit 1930 activates the interrupt handler (the interrupt processor 131) and performs an appropriate process (Step S2101). Then, the identification information detector 132 extracts flow information from the packet, so as to detect an entry, corresponding to the extracted flow information, in the alternate process management table 121 (Steps S2102 and S2103).

Assume that the flow information acquired from the received packet is the same as the flow information identified by the established SA. Although the flow information includes SPI in this example, flow information identifying no SPI may be generated depending on the contents of an alternate process.

The identification information detector 132 detects an entry including the flow information obtained from the received packet, in the alternate process management table 121 (Step S2103). In this example, an entry including the same flow information is already generated when the SA is established in the instruction sequence generation process. Thus, a relevant entry is detected (YES at Step S2103), and the generating unit 1935 checks whether an instruction sequence exists in this entry (Step S2105). In this example, an instruction sequence is already generated and registered in a registration process performed in advance. Thus, determination is made that an instruction sequence has been set (YES at Step S2105), information to be passed for the instruction sequence is prepared, and then a request for an alternate process is made by notifying the instruction sequence and such prepared information to the second arithmetic unit 140 (Step S2106).

According to the second embodiment, the above processes are repeated until the established SA becomes invalid. When the SA becomes invalid, the relevant entry is deleted from the alternate process management table 121 by deleting the registration.

A specific example of message processing for packet transmission according to the second embodiment will now be described. In the instruction sequence generation process, for example, an instruction sequence “Ins(N′s1)|Ins(Crypt′)|Ins(N′2s)” is generated. N′s1 is a transmission network process before encryption, Crypt′ is encryption, and N′2s is a transmission network process after encryption.

In the first embodiment, an alternate process (encryption at the SSL) is performed before a transmission network process. Thus, after an instruction sequence is generated, information including a process area is stored when a process requests an alternate process, and the actual processing is skipped. In the second embodiment, on the contrary, such a specific process as storing a process area is not required because an alternate process is performed between transmission network processes.

In the first embodiment, the instruction sequence Ins(C) is added as a specific example of determination conditions. In addition to such general condition, a condition unique to a specific process may be required to combine a plurality of instruction sequences. Such a situation is handled by applying the second embodiment and registering a plurality of instruction sequences in advance.

As such, a message processor according to the second embodiment can register an instruction sequence in advance according to a request from a process, and thereby enables the second arithmetic unit to sequentially perform a plurality of processes using the instruction sequence registered in advance. This prevents an increase in load on the main processor while reducing the overhead due to the complex processes and data movement, as in the first embodiment.

A message processing program to be implemented in a message processor according to the first or the second embodiment is recorded in an installable or executable file format, and provided as being recorded on a computer-readable recording medium, such as a compact disk read only memory (CD-ROM), a flexible disk (FD), a compact disk recordable (CD-R) disk, or a digital versatile disk (DVD).

A message processing program to be implemented in a message processor according to the first or the second embodiment may be stored on a computer connected to a network such as the Internet, and provided as being downloaded via the network. Alternatively, a message processing program to be implemented in a message processor according to the first or the second embodiment may be provided or distributed via a network such as the Internet.

A message processing program according to the first or the second embodiment may be provided as being installed in advance in a ROM or the like.

A message processing program to be implemented in a message processor according to the first or the second embodiment is realized by the above units configured as modules (the interrupt processor, the identification information detector, the packet processor, the process detector, the generating unit, the register unit, and the controller). As actual hardware configuration, a central processing unit (CPU) 51 (processor) reads out a message processing program from the above memory medium and implements it, so that the units are loaded in a main memory and generated therein accordingly.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A message processor comprising:
a first arithmetic unit capable of executing an instruction sequence defining processing content;
a second arithmetic unit capable of executing an instruction sequence being same as or different from the instruction sequence executed by the first arithmetic unit; and
a memory unit that stores therein process information in which associated identification information with an instruction sequence, the identification information being information for identifying a type of a message, and the instruction sequence being a sequence for sequentially performing a network process for transmission or reception of the message, and a specific process to be performed on the message in relation with the network process, wherein
the first arithmetic unit includes
an identification information detector that detects the identification information from the message, and
a controller that retrieves from the memory unit an instruction sequence corresponding to the identification information detected, so as to control the second arithmetic unit to perform the instruction sequence retrieved.

2. The message processor according to claim 1, wherein the first arithmetic unit includes
a first process detector that detects at least one of a process for inputting the message to be processed in the network process, and a process for outputting the message to be processed in the network process,
a second process detector that detects the specific process performed, so as to detect a process having requested execution of the specific process detected,
a generating unit that generates, when a process detected by the first process detector matches a process detected by the second process detector, the instruction sequence for sequentially performing the network process and the specific process detected, and
a register unit that registers in the memory unit the process information in which associated the identification information detected by the identification information detector with the instruction sequence generated by the generating unit.

3. The message processor according to claim 2, wherein the generating unit determines an execution sequence of the network process and the specific process detected, and generates the instruction sequence for performing, in the execution sequence determined, the network process and the specific process detected.

4. The message processor according to claim 1, wherein the first arithmetic unit includes
a reception unit that receives, from a first process being at least one of a process for inputting the message to be processed in the network process and a process for outputting the message to be processed in the network process, a registration request for registering the process information including the identification information, and process identification information for identifying the specific process requested by the first process to be performed,
a generating unit that generates the instruction sequence for sequentially performing the network process, and the specific process identified by the process identification information contained in the registration request received, and
a register unit that registers in the memory unit the process information in which associated the identification information contained in the registration request received with the instruction sequence generated.

5. The message processor according to claim 4, wherein
the reception unit receives sequence information indicating an execution sequence of the network process and the specific process detected, and
the generating unit generates the instruction sequence for performing, in the execution sequence indicated by the sequence information received, the network process, and the specific process identified by the process identification information contained in the registration request received.

6. The message processor according to claim 1, wherein
the memory unit stores therein the process information in which associated the identification information with the instruction sequence, the instruction sequence being sequence for sequentially performing the network process, a determination process for determining, based on a predetermined condition, whether the specific process is executable, and the specific process, and
the second arithmetic unit executes an instruction sequence for the specific process when an instruction sequence for the determination process is executed and the specific process is determined to be executable.

7. The message processor according to claim 6, wherein
the memory unit stores therein the process information in which associated the identification information and the instruction sequence, the instruction sequence being sequence for sequentially performing the network process, the determination process for determining, based on the condition being a message data size necessary for performing the specific process, whether the specific process is executable, and the specific process, and
the second arithmetic unit determines the specific process to be executable, when a data size of the message processed in the network process is greater than a predetermined threshold indicating the message data size necessary for performing the specific process.

8. The message processor according to claim 7, wherein
the controller notifies the threshold to the second arithmetic unit, and
the second arithmetic unit determines the specific, process to be executable, when the data size of the message processed in the network process is greater than the threshold notified.

9. The message processor according to claim 8, wherein the controller notifies, as the threshold, a data size of a message passed to a process requesting execution of the specific process to the second arithmetic unit.

10. The message processor according to claim 1, wherein the identification information is at least one of a source address, a destination address, a source port number, a destination port number, protocol information indicating an applicable protocol, and an identifier for identifying a parameter used in the protocol, all contained in the message.

11. The message processor according to claim 1, wherein
the memory unit stores therein the process information in which associated the identification information with the instruction sequence, the instruction sequence including an address of a first instruction sequence for performing the network process, an address of a second instruction sequence for performing the specific process, and sequence information indicating an execution sequence of the first and the second instruction sequences, and
the second arithmetic unit retrieves the first instruction sequence from the address of the first instruction sequence, and the second instruction sequence from the address of the second instruction sequence, so as to perform, in the execution sequence indicated by the sequence information, the first and the second instruction sequences retrieved, the addresses and the sequence information being contained in the instruction sequence.

12. The message processor according to claim 11, wherein
the memory unit stores therein the process information in which associated the identification information with the instruction sequence, the instruction sequence further including a first input address being an address of input data for the network process, a first output address being an address of output data for the network process, a second input address being an address of input data for the specific process, and a second output address being an address of output data for the specific process, and
the second arithmetic unit executes the first instruction sequence on the input data at the first input address, so as to output data as a processing result to the first output address, and executes the second instruction sequence on the input data at the second input address, so as to output data as a processing result to the second output address.

13. A method performed in a message processor for processing message, the message processor including a first arithmetic unit capable of executing an instruction sequence defining processing content, and a second arithmetic unit capable of executing an instruction sequence being same as or different from the instruction sequence executed by the first arithmetic unit, the method comprising:
detecting identification information from a message; and
retrieving from a memory unit an instruction sequence corresponding to the identification information detected in the detecting, so as to control the second arithmetic unit to perform the instruction sequence retrieved, the memory unit storing therein process information in which associated identification information with an instruction sequence, the identification information being information for identifying a type of a message, and the instruction sequence being a sequence for sequentially performing a network process for transmission or reception of the message, and a specific process to be performed on the message in relation with the network process.

14. A computer program product having a computer readable medium including programmed instructions executable by a computer for processing a message, the computer including
a first arithmetic unit capable of executing an instruction sequence defining processing content,
a second arithmetic unit capable of executing an instruction sequence being same as or different from the instruction sequence executed by the first arithmetic unit, and
a memory unit that stores therein process information in which associated identification information with an instruction sequence, the identification information being information for identifying a type of a message, and the instruction sequence being a sequence for sequentially performing a network process for transmission or reception of the message, and a specific process to be performed on the message in relation with the network process, wherein the instructions, when executed by the computer, cause the computer to perform
detecting the identification information from the message, and
retrieving from the memory unit an instruction sequence corresponding to the identification information detected, so as to control the second arithmetic unit to perform the instruction sequence retrieved.
